(19) United States
(12) Patent Application Publication
(10) Pub. No.: US 2016/0286011 A1
(43) Pub. Date: Sep. 29, 2016

(54) TECHNIQUES FOR COMMUNICATING AN END OF PACKET INDICATOR

(71) Applicants: ASSAF KASHER, HAIFA (IL); VLADIMIR KRAVTSOV, JERUSALEM (IL); MICHAEL GENOSSAR, MODIN (IL); TOM HAREL, SHFAIM (IL); ERAN GERSON, PARDES HANA (IL); SOLOMON TRAININ, HAIFA (IL)

(72) Inventors: ASSAF KASHER, HAIFA (IL); VLADIMIR KRAVTSOV, JERUSALEM (IL); MICHAEL GENOSSAR, MODIN (IL); TOM HAREL, SHFAIM (IL); ERAN GERSON, PARDES HANA (IL); SOLOMON TRAININ, HAIFA (IL)

(21) Appl. No.: 14/670,225

(22) Filed: Mar. 26, 2015

(51) Int. Cl. H04L 29/06; H04L 29/08

(52) U.S. Cl. CPC H04L 69/22; H04L 69/323

(57) ABSTRACT

Various embodiments are generally directed to an apparatus, method and other techniques to generate a packet comprising at least a preamble, a header including a PHY layer termination indicator, and data, determine an end of the packet based on information received from a media access control (MAC) layer, generate an end of packet indicator for the packet. Further, techniques may also include communicating the packet including the preamble, the PHY layer termination indicator, and the data as one or more blocks, at least a portion of the packet communicated with the end of packet indicator.

### TECHNICAL FIELD

Embodiments described herein generally relate techniques to communicate an end of packet indicator.

### BACKGROUND

Wireless communication systems communicate information over a shared wireless communication medium such as one or more portions of the radio-frequency (RF) spectrum. Recent innovations in Millimeter-Wave (mmWave) communications operating at the 60 Gigahertz (GHz) frequency band promises several Gigabits-per-second (Gbps) throughput. Current mmWave communications systems may communicate different types of information, such as video and multimedia streaming, with each type of information consuming different amounts of wireless resources. Typically, information is communicated between devices as one or more packets that include packet length in a header field. However, due to the amount of information communicated, packets are becoming longer and the length may be not be known at the commencement of communicating the packet. Moreover, information may be added to the packet after the header field has already be communicated and the actual length of the packet is unknown.

### BRIEF DESCRIPTION OF THE DRAWINGS

FIG. 1 illustrates an example embodiment of a computing system.

FIG. 2A illustrates an example embodiment of a second computing system.

FIG. 2B illustrates an example embodiment of a first packet structure.

FIG. 2C illustrates an example embodiment of a second packet structure.

FIG. 2D illustrates example embodiments of first and second processing flow diagrams.

FIG. 2E illustrates an example embodiment of a packet transmission.

FIG. 3 illustrates a second example embodiment of a packet transmission.

FIG. 4 illustrates a third example embodiment of a packet transmission.

FIG. 5 illustrates a fourth example embodiment of a packet transmission.

FIG. 6 illustrates example embodiments of third and fourth processing flow diagrams.

FIG. 7A illustrates an example embodiment of a fifth processing flow diagram.

FIG. 7B illustrates an example embodiment of a sixth processing flow diagram.

FIG. 7C illustrates an example embodiment of a seventh processing flow diagram.

FIG. 7D illustrates an example embodiment of an eighth processing flow diagram.

FIG. 8A illustrates an example embodiment of a logic flow.

FIG. 8B illustrates an example embodiment of a logic flow.

FIG. 9 illustrates an example embodiment of a computing device.

FIG. 10 illustrates an example embodiment of a computing architecture.

### DETAILED DESCRIPTION

Various embodiments are generally directed to techniques for operation in accordance with any specification, standards or variants suitable for communications operating around the 60 Gigahertz (GHz) frequency band as defined by Wireless Gigabit Alliance Wireless Gigabit (“WiGig”) Specification Version 1.0, according to Institute of Electrical and Electronics Engineers (IEEE) Standard P802.11ad-2012, published December 2012, titled “Amendment 3: Enhancements for Very High Throughput in the 60 GHz Band,” (“IEEE 802.11ad-2012”) or according to any predecessors, revisions, or variants thereof (collectively, “the WiGig/802.11ad Standards”); one or more of the WirelessHD™ specifications, standards or variants, such as the WirelessHD Specification, Revision 1.0d7, Dec. 1, 2007, and its progeny as promulgated by WirelessHD, LLC (collectively referred to as the “WirelessHD Specification”), or with any other wireless standards as promulgated by other standards organizations. Further, some embodiments may be directed for operation in accordance with the next generation (NG) 60 GHz communication standard. Various embodiments are not limited in this manner.

Moreover, embodiments may be directed to techniques to indicate an end of a packet by a physical (PHY) layer. Some embodiments may include determining whether a packet is PHY layer terminated and inserting a PHY layer termination indicator into a header of the packet. For example, a header may include one or more reserve bits that can be used as a PHY layer termination indicator. Thus, a receiving device may check these one or more bits to determine whether a packet is PHY layer terminated or not, for example.

The end of a packet may be indicated by the PHY layer in a number of different ways. For example, a controller at the PHY layer may append an inverted polarity guard interval sequence to a last data block of the end of the packet. In another example, a controller at the PHY layer may communicate one or more Golay sequences in parallel with a last two data blocks of the packet to indicate the end of the packet. Further, the Golay sequences may be communicated at a lower power than the data. In a third example, a controller at the PHY layer may append a pseudo-random sequence after a last byte of data prior to low-density parity-check (LDPC) encoding. In a fourth example, a controller at the PHY layer may append one or more Golay sequences after a last guard interval value of the packet. Various embodiments are not limited in this manner.

Further and in some embodiments, a controller at a PHY layer of a receiving device may determine whether a packet is PHY layer terminated based on an indicator in a header of a packet, as previously mentioned. The controller at the PHY layer of the receiving device may also detect the end of packet by determining whether an occurrence of one or more of the above techniques were used. Various embodiments are not limited in this manner.

Various embodiments also relate to an apparatus or systems for performing these operations. This apparatus may be specially constructed for the required purpose or it may include a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the contemplated method. Examples of the contemplated structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

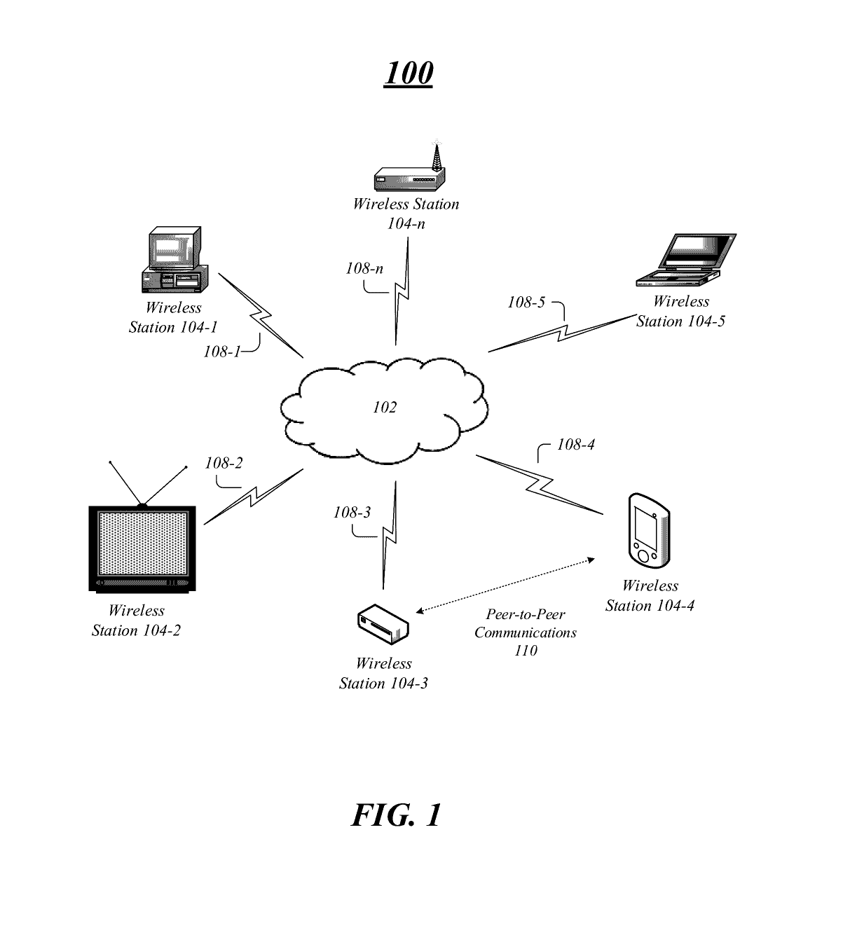

FIG. 1 illustrates a block diagram of one embodiment of a communications system 100. In various embodiments, the communications system 100 may include multiple stations or devices. A station generally may include any physical or logical entity for communicating information in the communications system 100 and may be implemented as hardware, software, or any combination thereof, as desired for a given set of design parameters or performance constraints. Although FIG. 1 may show a limited number of stations by way of example, it can be appreciated that more or less stations may be employed for a given implementation.

In various embodiments, the communications system 100 may include, or form part of a wired communications system, a wireless communications system, or a combination of both. For example, the communications system 100 may include one or more stations arranged to communicate information over one or more types of wired communication links. Examples of a wired communication link, may include, without limitation, a wire, cable, bus, printed circuit board (PCB), Ethernet connection, peer-to-peer (PTP) connection, backplane, switch fabric, semiconductor material, twisted-pair wire, co-axial cable, fiber optic connection, and so forth. The communications system 100 also may include one or more stations arranged to communicate information over one or more types of wireless communication links. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands.

The communications system 100 may communicate information in accordance with one or more standards as promulgated by a standards organization. In one embodiment, for example, various devices including part of the communications system 100 may be arranged to operate in accordance with any specification, standards or variants suitable for communications operating around the 60 Gigahertz (GHz) including the WiGig/802.11ad Standard, the Wireless HD Specification, IEEE 802.11ay Next Generation 60 GHz (hereinafter “NG60”) or any other wireless standards as promulgated by other standards organizations.

The communications system 100 may communicate, manage, or process information in accordance with one or more protocols. A protocol may include a set of predefined rules or instructions for managing communication among stations. In various embodiments, for example, the communications system 100 may employ one or more protocols such as a beam forming protocol, medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), a contention-based period (CBP) protocol, a distributed contention-based period (CBP) protocol and so forth. In various embodiments, the communications system 100 also may be arranged to operate in accordance with standards and/or protocols for media processing. The embodiments are not limited in this context.

As shown in FIG. 1, the communications system 100 may include a network 102 and a plurality of wireless stations 104-n, where n may represent any positive integer value. In various embodiments, the wireless stations 104-n may be implemented as various types of wireless devices. Examples of wireless devices may include, without limitation, a subscriber station, a base station, a wireless access point (AP), a wireless client device, a wireless station (STA), a laptop computer, ultra-laptop computer, portable computer, personal computer (PC), notebook PC, handheld computer, personal digital assistant (PDA), cellular telephone, combination cellular telephone/PDA, smartphone, pager, messaging device, media player, media server, digital music player, set-top box (STB), appliance, workstation, user terminal, mobile unit, consumer electronics, television, digital television, high-definition television, television receiver, high-definition television receiver, and so forth. In the illustrated embodiment shown in FIG. 1, the wireless stations 104-n may include a PC 104-1, a digital TV 104-2, a media source 104-3 (e.g., a CD, DVD, media file server, etc.), a handheld device 104-4, and a laptop or notebook 104-5. These are merely a few examples, and the embodiments are not limited in this context.

In some embodiments, the wireless stations 104-n may include one more wireless interfaces and/or components for wireless communication such as one or more transmitters, receivers, transceivers, chipsets, amplifiers, filters, control logic, network interface cards (NICs), antennas, antenna arrays, modules and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the wireless stations 104-n may include or form part of a wireless network 102. More specifically, the wireless stations 104-n may be directional multi-gigabit (DMG) stations (STAs) operative to communicate over wireless network 102 according to the WiGig/802.11ad Standards. Although some embodiments may be described with the wireless network 102 implemented as 60 GHz wireless network for purposes of illustration, and not limitation, it can be appreciated that the embodiments are not limited in this context. For example, the wireless network 102 may include or be implemented as various types of wireless networks and associated protocols suitable for a WVAN, WPAN, WLAN, WMAN, Wireless Wide Area Network (WWAN), Broadband Wireless Access (BWA) network, a radio network, a cellular radiotelephone network, a cable network, a television network, a satellite network such as a direct broadcast satellite (DBS) network, and/or any other wireless communications network configured to operate in accordance with the described embodiments.

The network 102 allows for peer-to-peer or ad hoc network communications 110 where the wireless stations 104-n may communicate directly with each other without necessarily needing a fixed device, such as a wireless access point. In one embodiment, for example, the network 102 provides for contention-based medium access, such as carrier sense multiple access (CSMA) technique, often combined with a collision avoidance (CA) technique for wireless networks (CSMA/CA). The CSMA/CA technique is intended to provide fair and equal access to the wireless stations 104-n, where each wireless station 104-n listens to the wireless shared medium before attempting to communicate. To accommodate bandwidth demanding and time-sensitive information, such as audio/video (AV) or multimedia streams, the network 102 may implement QoS techniques to implement controlled fairness. Traffic having a higher priority is given preferential access to the wireless shared medium, for example. Various embodiments are not limited to the above-recited examples and other configurations may be contemplated.

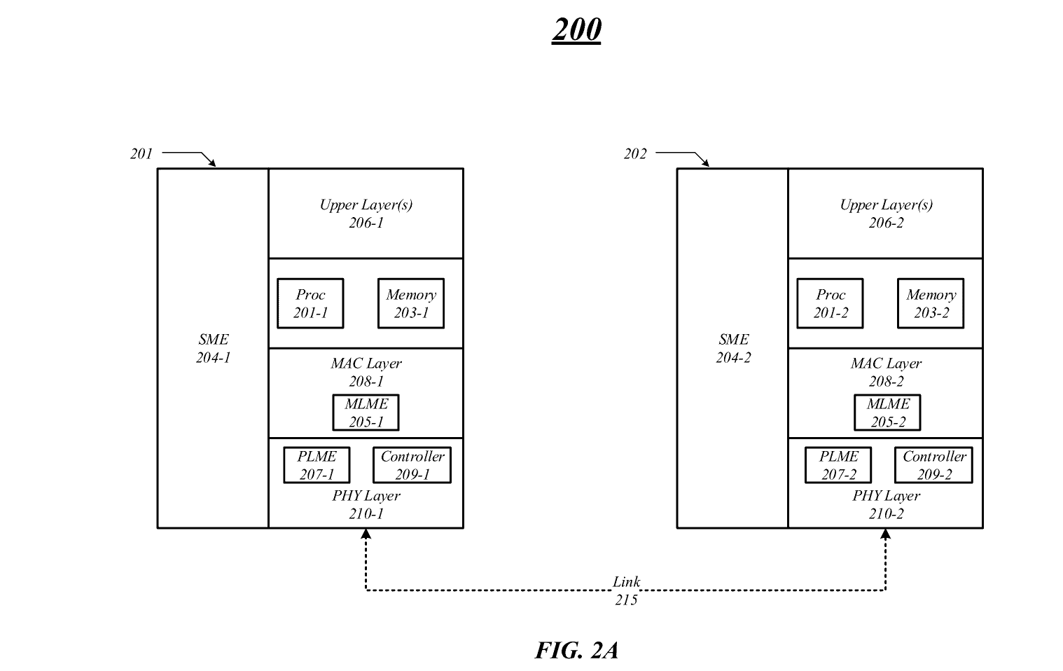

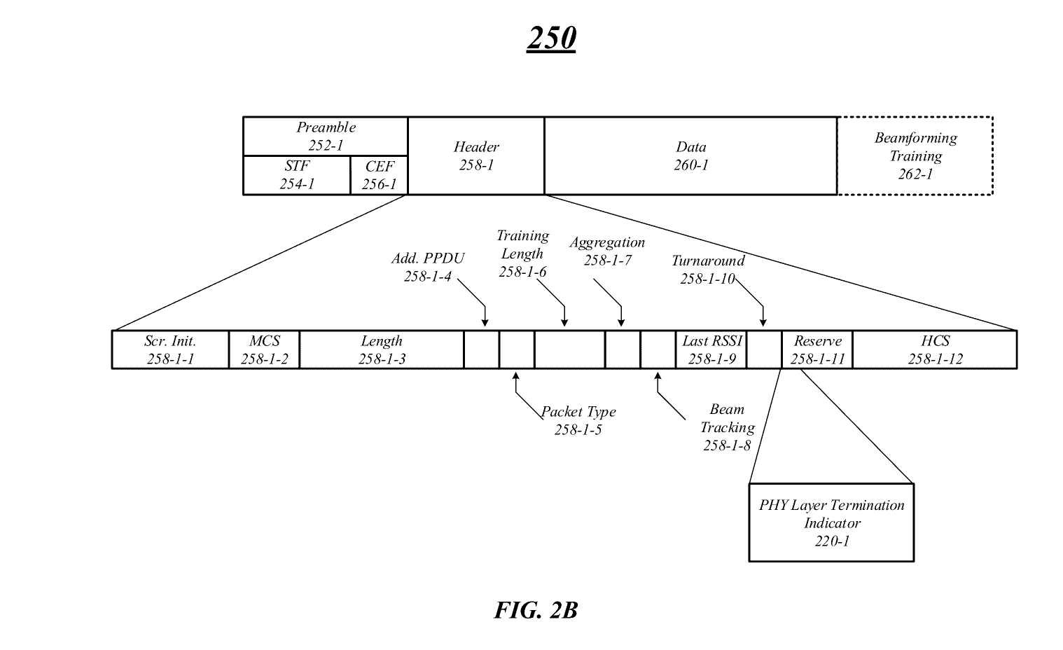

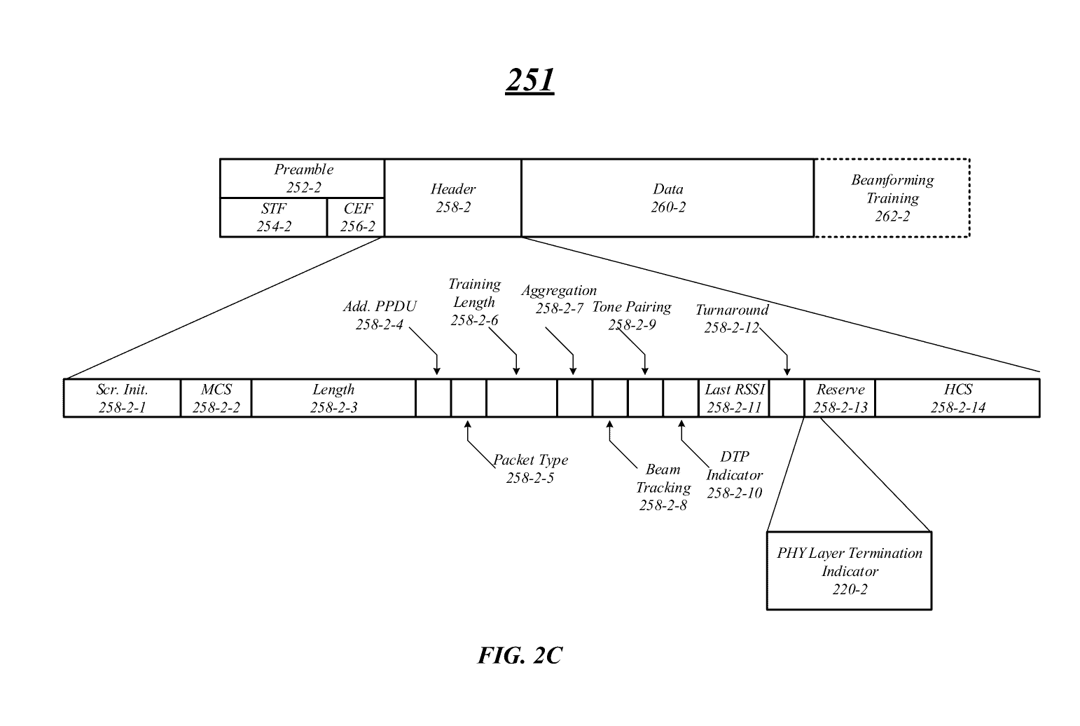

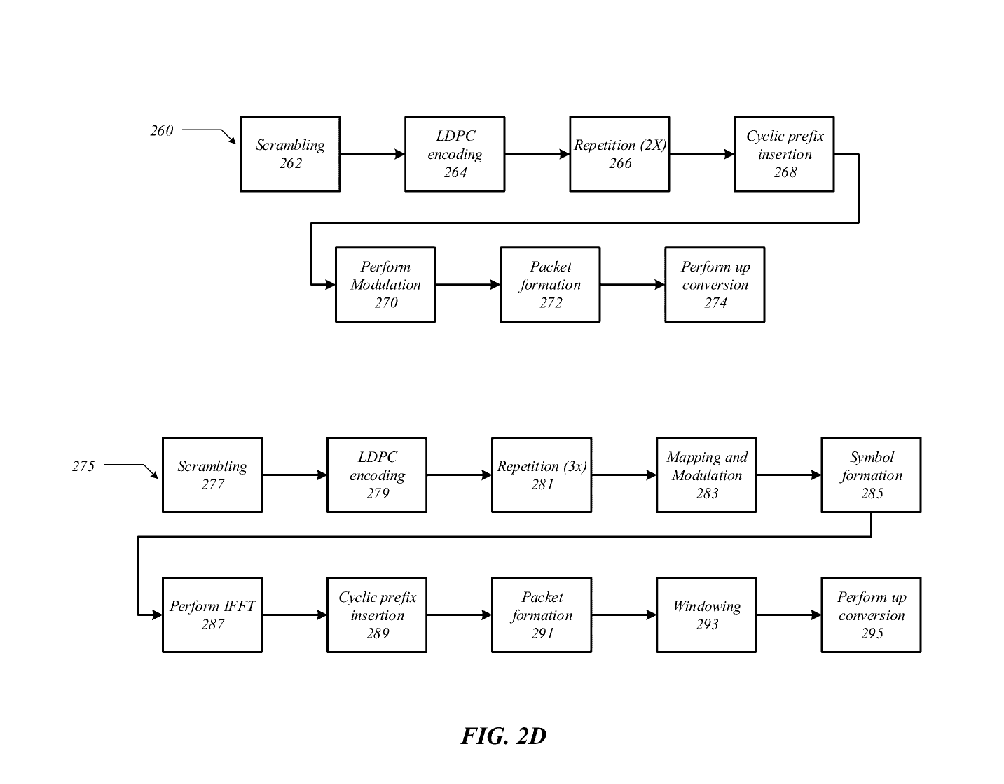

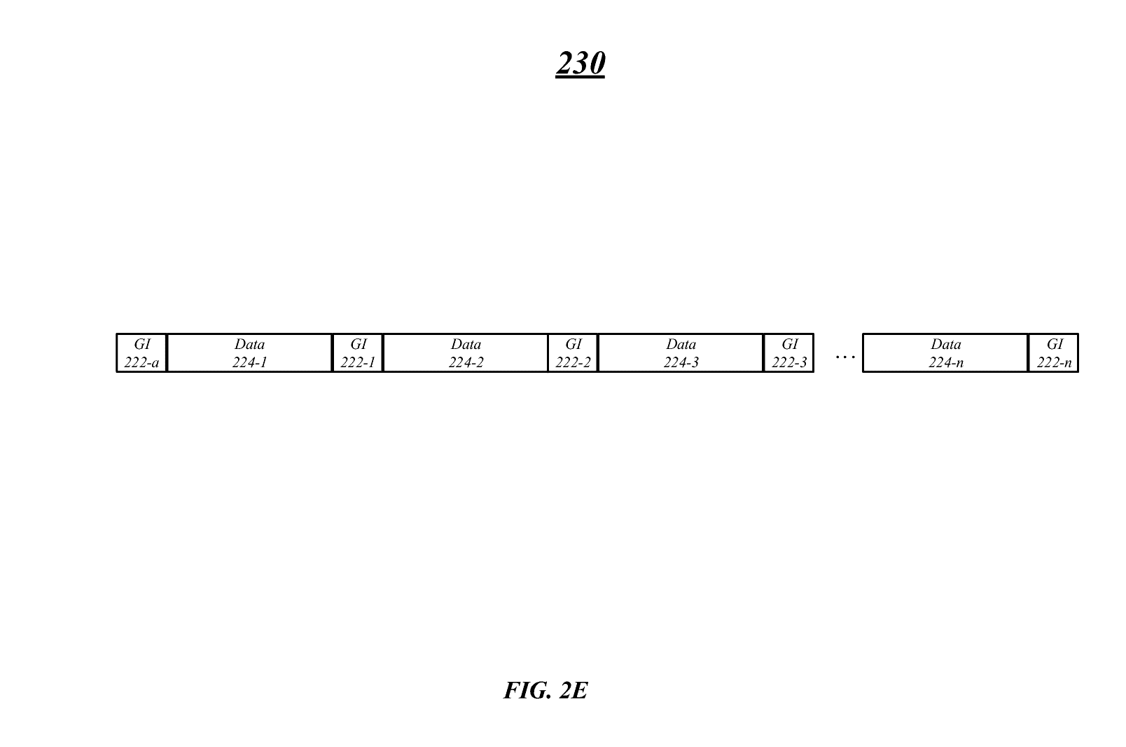

FIG. 2A illustrates an example embodiment of computing system 200 having stations 201 and 202 communicating information over a link 215. In embodiments, computing system 200 and stations 201 and 202 may operate in accordance of one or more standards, such as the WiGig/802.11ad Standards and/or NG60/802.11ay, as previously discussed above in FIG. 1. Further, FIG. 2A illustrates stations 201 and 202 including multiple “layers” in accordance with the Open Systems Interconnection (OSI) model. The OSI model standardizes internal functions of communications and groups communication functions into seven logical layers. Each of the layers may include circuitry and/or logic to process information. A layer serves the layer above it and is served by the layer below it. FIG. 2A illustrates stations 201 and 202 only have two specific layers, a medium access control (MAC) layer 208 and physical (PHY) layer 210, and upper layers 206 for simplicity purposes. In addition, although only two stations (STAs) are shown for simplicity, embodiments are not limited to any particular number of STAs.

Each STA 201 and 202 includes a station management entity (SME) 204 or a layer independent entity for processing generic primitives, determining layer statuses, and setting values of layer-specific parameters using a standard management protocol. In some embodiments, SME 204 may provide a mechanism for information to flow between each of the layers, such as the MAC layer 208 and the PHY layer 210. Moreover, each station 201 and 202 may include a PHY layer 210 having a PHY layer management entity (PLME) 207 and a MAC layer 208 having a MAC layer management entity (MLME) 205. The PLME 207 may control and process PHY layer 210 specific primitives and MLME 205 may control and process MAC layer 208 primitives. Further, the PLME 207 may provide layer management interfaces through which layer management functions may be invoked. In some embodiments, the PLME 207 may receive information from MLME 205, and vice versa. The information may be communicated in one or more protocol data units, such as a MAC protocol data unit (MPDU).

In addition, the PHY layer 210 may include circuitry and logic to implement physical layer functions. For example and in some embodiments, the PHY layer 210 may include a transceiver (not shown) to communicate via a wireless link 215 through antenna. In various embodiments, the PHY layer 210 may communicate one or more packets, such as packet 250 of FIG. 2B and/or packet 251 of FIG. 2C between station 201 and station 202. Further and during transmission, the packets may be divided into a number of blocks including symbols for communicating between the stations 201 and 202. The blocks may include any number of symbols based on one or more standards and/or a modulation scheme used for communication. The packets may be divided in this manner to ensure a receiving station remains synchronized with the sending station during the entire packet transmission.

Moreover, the packets may be communicated using various encoding and modulation schemes according to one or more standards, such as IEEE WiGig/802.11ad Standards and/or NG60/802.11ay. For example, the packets may be communicated by the PHY layer 210 using orthogonal frequency division multiplexing (OFDM) or multi-carrier modulation which utilizes multiple sub-carriers to transport information between the stations 201 and 202. In another example, the packets may be communicate by the PHY layer 210 using single carrier (SC) modulation schemes which uses a single carrier to transport information between the stations 201 and 202. These and other details will become more apparent in the following description.

In embodiments, the PHY layer 210 may also include a PHY layer controller 209 which may include circuitry and logic to perform any number of operations and functions. For example and as will discussed in more detail below, the PHY layer controller 209 may perform one or more of the functions or operations discussed in processing flows 260 and 275 to send a packet and processing flows 600 and 650 to receive a packet.

In addition, the PHY layer controller 209 may control and execute other PHY layer operations and functions discussed herein, including, generating PHY layer packets for communication, determining whether a frame received from the MAC layer 208 is a PHY layer terminated packet, determining an end of a packet for PHY layer terminated packet, generating a PHY layer termination indicator, and generating an end of packet indicator for the PHY layer terminated packet, for example.

In some embodiments, the PHY layer controller 209 may determine a packet is PHY layer terminated based on whether information for the packet remains in a MAC buffer (not shown) while the packet is being generated and/or communicated at the PHY layer 210, for example. In another example, the PHY layer controller 209 may determine a packet is PHY layer terminated based on information received from the MAC layer 208. More specifically, the MAC layer 208 may communicate information to the PHY layer controller 209 indicating the packet is a PHY layer terminated packet. Similarly, the PHY layer controller 209 may also determine the end of packet based on whether information remains in a MAC buffer (not shown) and/or the MAC layer 208 expressly indicates the end of the packet or information. Various embodiments are not limited in this manner.

The PHY layer controller 209 may also generate packets to send to another device based on information from the MAC layer 208. For PHY layer terminated packets, the PHY layer controller 209 may generate and insert a PHY layer termination indicator into a header of the packet. More specifically, the PHY layer controller 209 may use and set one or more bits of a reserve field in a header of a packet to indicate the packet is PHY layer terminated. A receiving device, and in particular, a PHY layer controller 209 on a receiving device may use this information as an indication the packet is PHY layer terminated and to determine the end of the packet.

In some embodiments, the PHY layer controller 209 may include an end of packet indicator with the packet. For example, the PHY layer controller 209 may append or invert the polarity of a last guard interval to indicate to a PHY layer controller 209 at a receiving device an end of packet. In another example, the PHY layer controller 209 may communicate, at lower power than the packet signal, one or more Golay sequences in parallel with the last two blocks of the packet to indicate an end of a packet. The receiving device's PHY layer controller 209 may detect the one or more Golay sequences to determine the end of the packet. In a third example, the PHY layer controller 209 may append one or more Golay sequences after a last guard interval of a packet to indicate the end of a packet to a receiving device's PHY layer controller 209. In a fourth example, a PHY layer controller 209 may insert a pseudo-random sequence in the packet after scrambling has been performed on the information, but before LDPC encoding is performed. In this example, the receiving device's PHY layer controller 209 may detect the pseudo-random sequence in a bit pattern output of the LDPC decoding. The receiving device's PHY layer controller 209 may detect this pattern as an end of packet sequence and terminate the packet. If the sequence, by chance, appears at the real data of the packet (after scrambling), the receiving device may determine that the packet has ended before it really ends. However, on the next retransmission a different scrambler seed will be used and therefore the sequence will not appear in the middle of the packet. The receiving device's PHY layer controller 209 may use this information to determine the end of the packet.

In embodiments, each station 201 and 202 may include one or more processors 201. Processor 201 may include, for example, a Central Processing Unit (CPU), a Digital Signal Processor (DSP), a microprocessor, a controller, a chip, a microchip, an Integrated Circuit (IC), or any other suitable multi-purpose or specific processor or controller. Processor 201 may, for example, process data received by the stations and/or process data intended for transmission by stations.

Each station 201 and 202 may also include a memory unit 203 which may be, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. Memory unit 203 may store data received and/or store data intended for transmission. Further, memory unit 203 may store one or more instructions for carrying out the operation of station 201 and 202 including various embodiments disclosed herein.

FIGS. 2B/2C illustrate example embodiments of packet 250 and 251. More specifically FIGS. 2B and 2C show example packet structures for different modulation types in the WiGig/802.11ad Standards and NG60/802.11ay. In an implementation, the modulation types may include, a SC modulation packet 250 and OFDM modulation packet 251. Each of the packets 250 and 251 may include a preamble 252 including a short training field (STF) 254 and a channel estimation field (CEF) 256. The STF 254 and the CEF 256 may help signal acquisition, automatic gain control training, predicting the characteristics of the channel for the decoder, frequency offset estimation and synchronization. Each of the STF 254 and the CEF 256 may include one or more 128 symbol Golay sequences. Golay complementary sequences are sequences of bipolar symbols (±1) that have been mathematically constructed to have very specific autocorrelation properties, e.g. sum to zero. In some embodiments, system 200 may use Golay sequences having a different number of symbols such as a 32, 64, 128, or 256.

In addition to the preamble 252, each of the packets 250 and 251 include a header 258, data 260, and optional beamforming training 262. The data 260 and the optional beamforming training 262 may include standard packet formats and structures for transmission of the data 260 in the WiGig/802.11ad Standards. However, the header 258 may include information to indicate the packets 250 and 251 are PHY layer terminated packets. As previously mentioned, a packet may be PHY layer terminated if an end of packet was determined at the PHY layer 210 and based on information at the MAC layer 208, e.g. information in a MAC buffer or indication from the MAC layer 208. Further and in instances when the packet is PHY layer terminated, an end of packet indicator may be generated and communicated by the PHY layer 210. In other words, the PHY layer 210, and in particular, a PHY layer controller 209 may indicate whether a packet is PHY layer terminated or not, and the actual end of a PHY layer terminated packet.

In the illustrated embodiments, x is 1 for the SC modulation packet 250 and 2 for the OFDM modulation packet 251. In embodiments, a header 258 may include a number of fields similar to those defined by the WiGig/802.11ad Standards. For example, a header 258 may include a scrambler initialization field 258-x-1 which includes seed information a scrambler uses to perform data “whitening.” The header 258 may also include a modulation and coding scheme (MCS) field 258-x-2 to indicate the modulation and coding used in the payload (data) of the packet. A length field 258-x-3 may also be included in the header 258 and typically includes a length or number of octets of data in the payload of the packet. However, in embodiments when a packet is PHY layer terminated, the length field 258-x-3 may include a maximum length value and indicate a maximum number of octets of data in the payload, for example. In another example, the length field 258-x-3 may be set to a zero value if the packet is PHY layer terminated. Various embodiments are not limited in this manner.

The header 258 may also include a number of other fields including an additional PHY protocol data unit (PPDU) field 258-x-4, a packet type field 258-x-5, a training length field 258-x-6, an aggregation field 258-x-7, and a beam tracking field 258-x-8. In addition, the header 258-1 of the SC modulation packet 250 may include a last received signal strength indication (RSSI) field 258-1-9, a turnaround field 258-1-10, a reserve field 258-1-11, and a header check sequence field (HCS) field 258-1-12. Similarly, the header 258-2 of the OFDM modulation packet 251 may also include a last RSSI field 258-2-11, a turnaround field 258-2-12, a reserve field 258-2-13, and a HCS field 258-2-14. In addition, the header 258-2 may also include a tone pairing field 258-2-9 and a dynamic tone pairing (DTP) indicator field 258-2-10.

In some embodiments, one or more bits of the reserve field 258-1-11 and 258-2-13 may be used to indicate that a packet is PHY layer terminated. More specifically, each of the headers 258 in the packets 250 and 251 may include a PHY layer termination indicator field 220 to indicate to a receiving station that a packet is PHY layer terminated. For example, a single bit in the PHY layer termination indicator field 220 may include a PHY layer termination indicator. The PHY layer termination indicator field 220 may be set to 1 to indicate a packet is PHY layer terminated, for example. Various embodiments are not limited in this manner, 0 may indicate a packet is PHY layer terminated, for example. Further, more than one bit in the PHY layer termination indicator field 220 may be used to indicate PHY layer termination. A receiving device may use the indication in the PHY layer termination field 220 to prepare and detect a PHY layer 210 generated end of packet indicator. As will be discussed in more detail below. In the case that in a forthcoming 802.11ay amendment, an additional header will be added to the current 802.11ad header, the PHY layer terminator indicator field may be a part of this additional header.

Although FIGS. 2A and 2B only show a SC modulation packet 250 and an OFDM modulation packet 251 having a PHY layer termination indicator field 220, various embodiments are not limited in this manner. Other packet types, such as a control packet and a low power SC modulation packet may be PHY layer terminated and include a PHY layer termination indicator field.

FIG. 2D illustrates example embodiments of processing flows 260 and 275 for processing performed at the PHY layer 210 by a PHY layer controller 209, for example. More specifically, processing flow 260 illustrates processing of information for transmission of a SC modulation packet and processing flow 275 illustrates processing of information for transmission of an OFDM modulation packet. In various embodiments, the PHY layer controller 209 included hardware only, software only, or combination thereof to process information including generating one or more SC modulation packets and/or OFDM modulation packets.

With respect to processing flow 260, information received from the MAC layer 208 may be scrambled using a polynomial, such as X⁷+X⁴+1 at block 262. For example, header and data fields following the scrambler initialization field, as described above in FIGS. 2B and 2C, are scrambled by performing a XORing operation on each bit in turn with a 127 length period sequence generated by the polynomial. This scrambling operation removes long strings of ones and zeros if present in the information from the MAC layer 208 and will help with time synchronization and PAPR reduction at the receiving device.

At block 264, low-density parity-check (LDPC) encoding may be performed on the information. The LDPC encoding may be a block code and perform forward error correction. In some embodiments, the LDPC encoding may generate a codeword having a block size of 672 bits, for example. Further, codeword can have any number of different code rates based a number of payload bits.

In embodiments, processing flow 260 may perform repetition, e.g. 2×, to the header of the packet at block 266. In addition and at block 268, the processing flow 260 may include cyclic prefix insertion or guard interval insertion. For example, a guard interval may be inserted to eliminate intersymbol interference from a previous symbol. As will be discussed in more detail, a guard interval may be applied to the end of each block, and in some instances, an inverted polarity guard interval may be inserted at the end of the last block for a packet to indicate an end of the packet.

Processing flow 260 may include performing single carrier modulation and coding at block 270. The modulation scheme defines the modulation and code rate that is used in a PPDU and may include π/2-BPSK, π/2-QPSK and π/2-16QAM modulation. Further and at block 272, a packet may be formed, such as packet 250 illustrated in FIG. 2B. The packet may be an SC structured packet that includes a preamble, a header, a payload (data), and optional beamforming information. Finally, an up conversion may be performed at block 274 to convert baseband data to radio frequency (RF) modulated data to be transmitted over air. Various RF frequencies are support, such as 60 GHz.

Similarly, processing flow 275 may be include one or more blocks for processing an OFDM modulation packet at the PHY layer 210. For example, at block 277, information received from the MAC layer 208 may be scrambled using a polynomial, such as X⁷+X⁴+1. More specifically, header and data fields following the scrambler initialization field, as described above in FIGS. 2B and 2C, are scrambled by performing a XORing operation on each bit in turn with a 127 length period sequence generated by the polynomial. This scrambling operation removes long strings of ones and zeros if present in the information from the MAC layer 208 and will help with time synchronization and PAPR reduction at the receiving device.

At block 279, low-density parity-check (LDPC) encoding may be performed on the information. The LDPC encoding may be a block code and perform forward error correction. The LDPC encoding may generate a codeword having a block size of 672 bits, for example. The codeword can have any number of different code rates based a number of payload bits.

In embodiments, processing flow 275 may perform repetition, e.g. 3×, to the header of the packet at block 281. In addition and at block 283, the processing flow 275 may include performing carrier mapping to map data points to data carriers and modulation to convert bits into complex symbols. The modulation and coding scheme specifies the modulation and code rate used in the PPDU, including SQPSK, QPSK, and 16-QAM, and can be at a number of different codes rates.

At block 287, an Inverse Fast Fourier Transformation (IFFT) may be performed on the information to convert frequency domain data symbols to time domain data symbols. In some embodiments, a 512-point IFFT may be performed on the information. Further and at block 289 cyclic prefix insertion or guard interval insertion may be performed.

Processing flow 275 may also include forming a packet, such as packet 251 illustrated in FIG. 2C at block 291. The packet may be an OFDM structured packet that includes a preamble, a header, a payload (data), and optional beamforming information. Further, a window function may be performed on the information to smooth the transition between adjacent fields in the OFDM modulation packet at block 293. Finally, an up conversion may be performed at block 295 to convert baseband data to radio frequency (RF) modulated data to be transmitted over air. Various RF frequencies are support, such as 60 GHz.

FIG. 2E illustrates an example embodiment of the data portion of a packet transmission 220 having a block structure, such as packet 250 of FIG. 2B. The packet transmission 220 illustrated in FIG. 2E may have a typical block structure used in communicating a data portion of an SC modulation packet and may be the result of processing flow 260. Data transmission of an OFDM modulation packet may have a similar block structure, but include cyclic prefix (CP) blocks. As mentioned, a packet may be divided into a number of data blocks 224-n, each followed by a guard interval (GI) 222-n, where n may be any positive integer. Further, the first data block 224-1 may be proceeded by an initial guard interval 222-a. The packet may be divided into any number of data blocks 224 and GIs 222 may be added after each data block 224 to ensure packet synchronization at the receiving device. The number of data blocks 224 and GIs 222 may be based on an amount of data in the payload of a packet.

In various embodiments, the data block 224 may have any number of symbols or bits and may be based on a type of packet. For example, a SC modulation packet may include 448 symbols of data in each data block 224. However, various embodiments are not limited in this manner and different packets types may have a different number of symbols in a data block 224. Further, a GI 222 may be a Golay sequence having any number symbols, e.g. 64 symbols for a SC modulation. Similarly, different packet types may have a guard interval having a Golay sequence with a different number of symbols. Various embodiments are not limited in this manner.

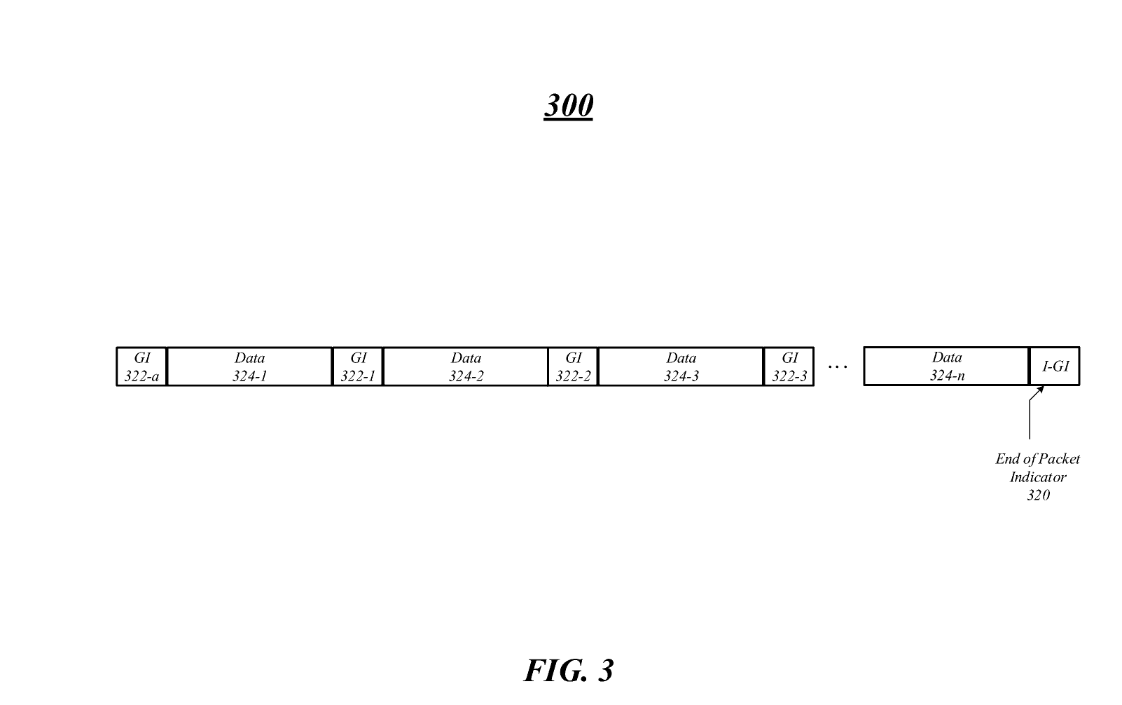

FIG. 3 illustrates an example embodiment of a packet transmission 300 having a block structure of a packet including a PHY layer terminated end of packet indicator. The packet transmission 300 may be similar to the packet transmission 220 illustrated in FIG. 2E. As mentioned, a packet may be divided into any number of data blocks 324-n, each followed by a guard interval (GI) 322-n, where n may be any positive integer. Further, the first data block 324-1 may be proceeded by an initial guard interval 322-a. The packet may be divided into data blocks 324 and GIs 322 may be added to ensure packet synchronization at the receiving device. The number of data blocks 324 and GIs 322 may be based on an amount of data in the payload of a packet.

In various embodiments, the data blocks 324 may have any number of symbols or bits and may be based on a type of packet. For example, a SC modulation packet may include 448 symbols of data in a data block 324. However, various embodiments are not limited in this manner and different packets types may have a different number of symbols in a data block 324. Further, a GI 322 may be a Golay sequence having a number symbols, e.g. 64 symbols for a SC modulation packet. Moreover, different packet types may have a guard interval having a Golay sequence with a different number of symbols.

In some embodiments, a PHY layer terminated packet may include an end of packet indicator 320. For example, the packet transmission 300 may include an end of packet indicator 320 after the last data block 324-n. As previously discussed, a packet communicated using a typically block structure, such as packet transmission 220, may include a GI after the last data block 324-n. However, in embodiments an end of packet indicator 320 may be added after the last data block 324-n instead of a typical GI. More specifically, the end of packet indicator 320 may be a GI 322 used previously in the packet transmission 300 but with inverted polarity. Thus, a receiving device may detect the end of packet indicator 320 by checking a correlation coefficient between a currently received GI and another previously received GI 322 to determine whether the currently received GI has inverted polarity and is the end of packet indicator 320. In some embodiments, the receiving device may check for the end of packet indicator 320 based on whether a PHY layer termination indicator 220 is in a header 258 indicating the packet is a PHY layer terminated packet, for example.

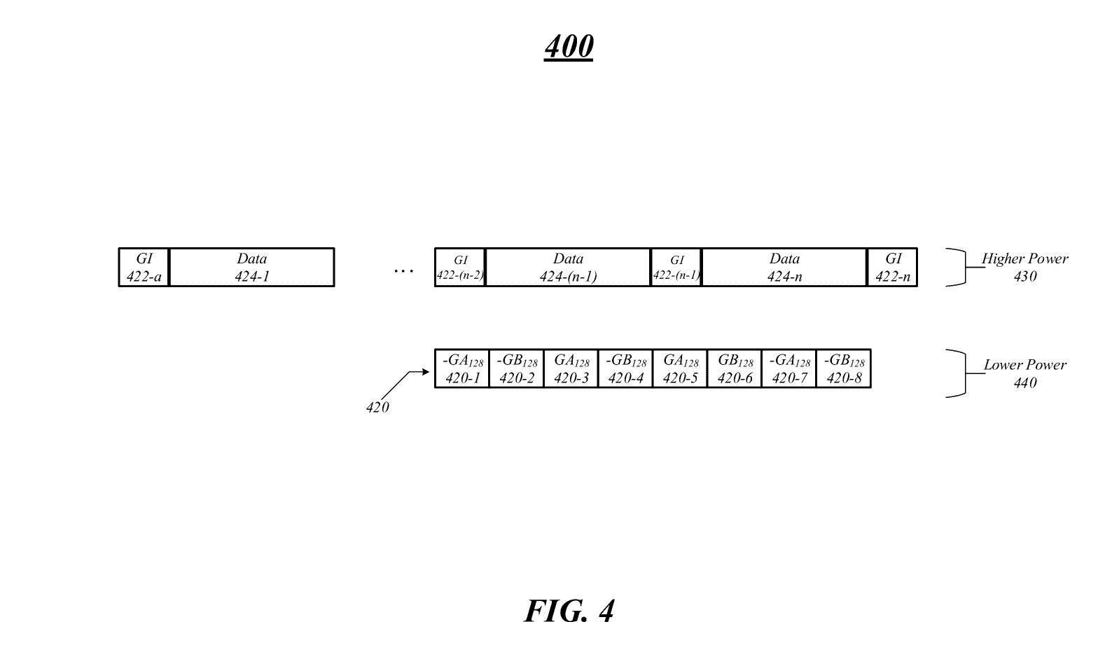

FIG. 4 illustrates an example embodiment of a packet transmission 400 having a block structure of a packet and a PHY layer terminated end of packet indicator. The packet transmission 400 may be similar to the packet transmission 220 illustrated in FIG. 2E. Further, the end of packet indicator 420 illustrated in FIG. 4 may be used for both SC modulated packets and OFDM modulated packets. As mentioned, a packet may be divided into any number of data blocks 424-n, each followed by a guard interval (GI) 422-n, where n may be any positive integer, and in some instances, may include cyclic prefix blocks (not shown). Further, the first data block 424-1 may be proceeded by an initial guard interval 422-a. The packet may be divided into data blocks 424 and GIs 422 may be added to ensure packet synchronization at the receiving device and to enable frequency domain equalization of the data blocks. The number of data blocks 424 and GIs 422 may be based on an amount of data in the payload of a packet.

In various embodiments, the data blocks 424 may have any number of symbols or bits and may be based on a type of packet. For example, a SC modulation packet may include 448 symbols of data in a data block 424. However, various embodiments are not limited in this manner and different packets types may have a different number of symbols in a data block 424. Further, a GI 422 may be a Golay sequence having a number symbols, e.g. 64 symbols for a SC modulation packet or an OFDM modulation packet. Moreover, different packet types may have a guard interval having a Golay sequence with a different number of symbols. Various embodiments are not limited in this manner.

In some embodiments, a PHY layer terminated packet may include an end of packet indicator 420. For example, the packet transmission 400 may include an end of packet indicator 420 including one or more Golay sequences communicated in parallel with the last two data blocks 424-(n−1) and 424-n of the block transmission. In some embodiments, the Golay sequences may be communicated at a lower power 440 than the block transmission including the data blocks 424 which are communicated at a higher power 430. For example, the end of packet indicator 420 may be communicated at 20 decibels (dB) below the block transmission of the data to limit interference to the data signal signals.

In embodiments, the one or more Golay sequences 420-1 through 420-8 may be any combination of eight 128 symbol Golay sequences. However, various embodiments may not be limited in this manner and a different number of Golay sequences and/or a different number of symbols may be used to indicate an end of packet. In some embodiments, one or more of the eight 128 symbol sequences 420-1 through 420-8 may use one or more of the Golay sequences used in the STF field 254 and/or the CEF field 256 of the preamble of the packet. The receiving device may check for the end of packet indicator 420 based on whether a PHY layer termination indicator 220 is in a header 258 indicating the packet is a PHY layer terminated packet, for example.

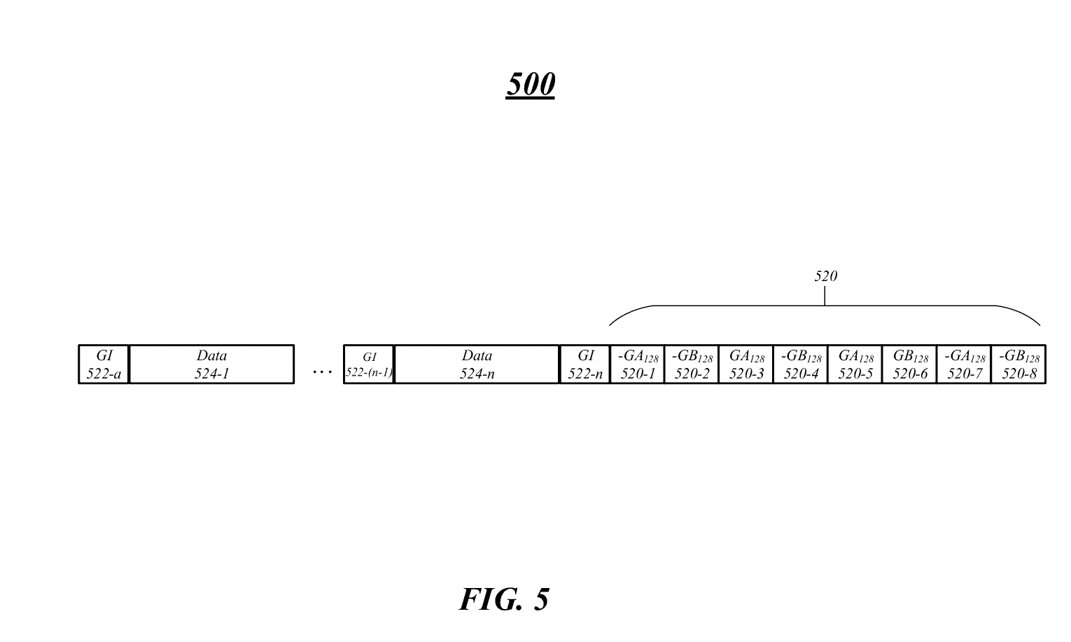

FIG. 5 illustrates an example embodiment of a packet transmission 500 having a block structure of a packet including a PHY layer terminated end of packet indicator. The packet transmission 500 may be similar to the packet transmission 220 illustrated in FIG. 2E. Further, the end of packet indicator 520 illustrated in FIG. 5 may be used for both SC modulated packets and OFDM modulated packets. As mentioned, a packet may be divided into any number of data blocks 524-n, each followed by a guard interval (GI) 522-n, where n may be any positive integer, and in some instances, may include cyclic prefix blocks (not shown). Further, the first data block 524-1 may be proceeded by an initial guard interval 522-a. The packet may be divided into data blocks 524 and GIs 522 may be added to each block to enable frequency domain equalization of the data blocks. The number of data blocks 524 and GIs 522 may be based on an amount of data in the payload of a packet.

In various embodiments, the data blocks 524 may have any number of symbols or bits and may be based on a type of packet. For example, a SC modulation packet may include 448 symbols of data in a data block 524. However, various embodiments are not limited in this manner and different packets types may have a different number of symbols in a data block 524. Further, a GI 522 may be a Golay sequence having a number symbols, e.g. 64 symbols for a SC modulation packet or an OFDM modulation packet. Moreover, different packet types may have a guard interval having a Golay sequence with a different number of symbols. Various embodiments are not limited in this manner.

In some embodiments, a PHY layer terminated packet may include an end of packet indicator 520. For example, the packet transmission 500 may include an end of packet indicator 520 including one or more Golay sequences communicated after the last GI 522-n of the block transmission. In some embodiments, the Golay sequences may be communicated on one or more carriers or sub-carriers at a same power level as the data blocks 524.

In embodiments, the one or more Golay sequences 520-1 through 520-8 may be any combination of eight 128 symbol Golay sequences. However, various embodiments may not be limited in this manner and a different number of Golay sequences and/or a different number of symbols may be used to indicate an end of packet. For example, Golay sequences having 32, 64, 128, or 256 may be used. In some embodiments, one or more of the Golay sequences 520-1 through 520-8 may use one or more of the Golay sequences used in the STF field 254 and/or the CEF field 256 of the preamble of the packet. However various embodiments are not limited in this manner. In some embodiments, the receiving device may check for the end of packet indicator 520 based on whether a PHY layer termination indicator 220 is in a header 258 indicating the packet is a PHY layer terminated packet, for example.

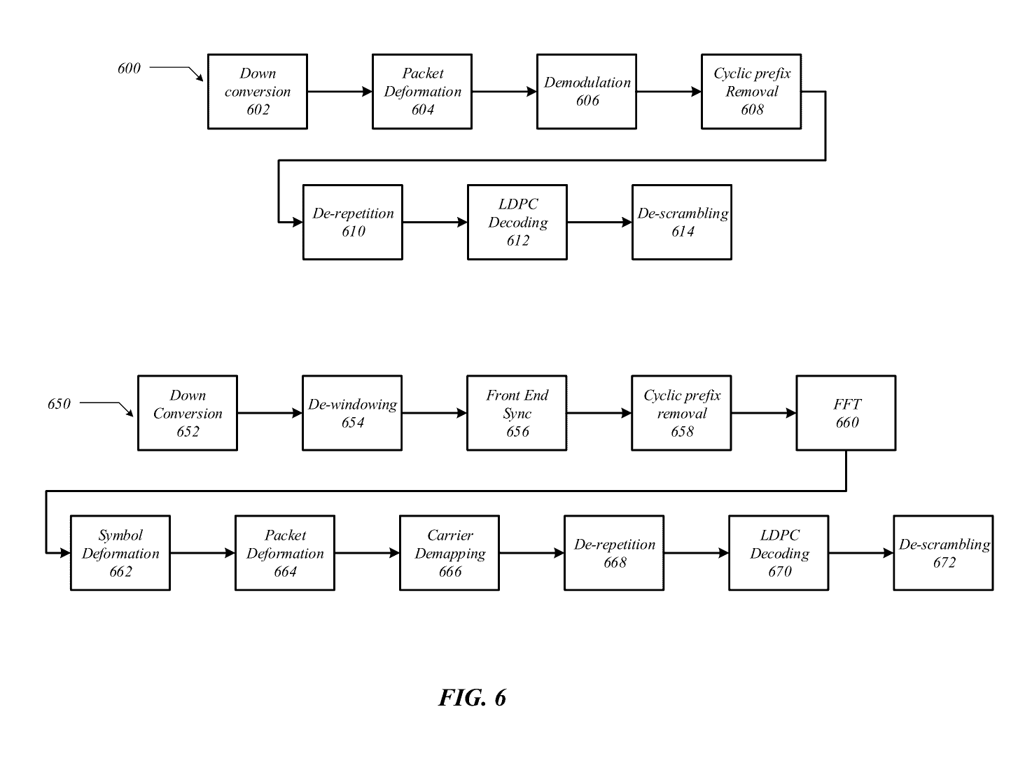

FIG. 6 illustrates example embodiments of processing flows 600 and 650 for processing a received packet performed at the PHY layer 210 by a PHY layer controller 209, for example. More specifically processing flow 600 illustrates processing of an SC modulation packet and processing flow 650 illustrates processing of an OFDM modulation packet. In embodiments, processing flow 600 may be the reverse process of processing flow 260 and processing flow 650 may be the reverse process of processing flow 275 illustrated in FIG. 2D. In embodiments, the PHY layer controller 209 may include hardware only, software only, or combination thereof to process a received packet.

In embodiments, processing flow 600 may include receiving one or more blocks of a packet and performing a down conversion at block 602. Next and at block 604 packet deformation is performed on the one or more received blocks, e.g. the packet header and payload information are determined. For example, the MCS used on the packet may be determined based on information in the header. For example and at block 606 demodulation may be performed on the packet based on the determined MCS information, for example.

Once the one or more packets are demodulated, the processing flow 600 may include performing cyclic prefix removal at block 608 and de-repetition at block 610. Further and at block 612, LDPC decoding may be performed on the packet. Typically a sum-product algorithm is applied to the packet until a valid codeword is determined or a maximum number of iterations is performed, for example. In various embodiments, descrambling may be performed at block 614. More specifically, a descrambler may descramble the decoded bits to generate a same sequence as the source input and MAC data to send to a MAC layer 208.

FIG. 6 also illustrates processing flow 650 which may be similar to processing flow 600. At block 652 down conversion may be performed on the received packet. Further, de-windowing may be performed on the down converted information at block 654. Next, front end synchronization may be performed at block 656. For example, the start of the received packet may be detected by way of a threshold detection function that differentiates between noise and the received packet. In some embodiments, a coarse time offset estimation and correction may be determined.

The processing flow 650 may also include performing cyclic prefix removal at block 658. At block 660 a fast Fourier transformation (FFT) may be performed on the packet. For example, a fine time offset estimation and correction and frequency offset estimation and correction may be performed. Further, complex channel response coefficients may be determined using channel estimation in the frequency domain using the preamble of the packet. In addition, channel equalization is performed using the estimated channel response coefficients for each of the symbols in the packet. Finally, phase rotation may be performed using the estimated phase rotation using pilot sub-carriers embedded in the symbols.

In embodiments, the processing flow 650 may include symbol deformation at block 662 and packet deformation at block 664. The processing flow 650 may also include performing carrier demapping at block 666. For example, carrier demapping may be performed on the subcarriers as determined by information in the MCS of the packet. The demapping may be QPSK, 16-QAM or 64-QAM. After the demapping, de-repetition may be performed for the header at block 668 and LDPC decoding may be performed at block 670. Finally, descrambling may be performed at block 672 to determine the MAC data. Various embodiments are not limited to the above description for processing flows 600 and 650 and various other operations and functions may be performed on the received packet. In addition, certain blocks are described as occurring in a particular manner, however, various embodiments are not limited this way and the blocks may occur in a number of different ways.

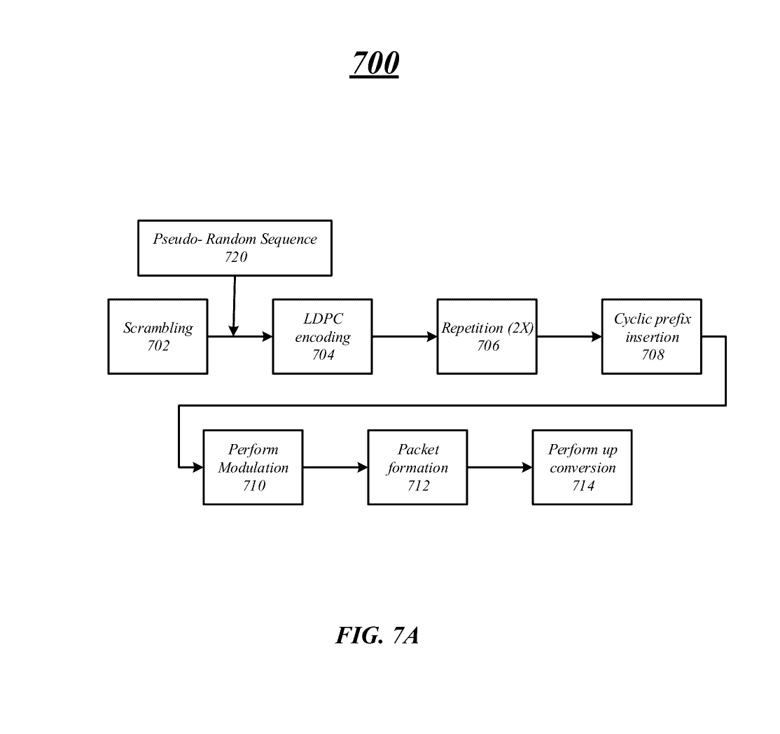

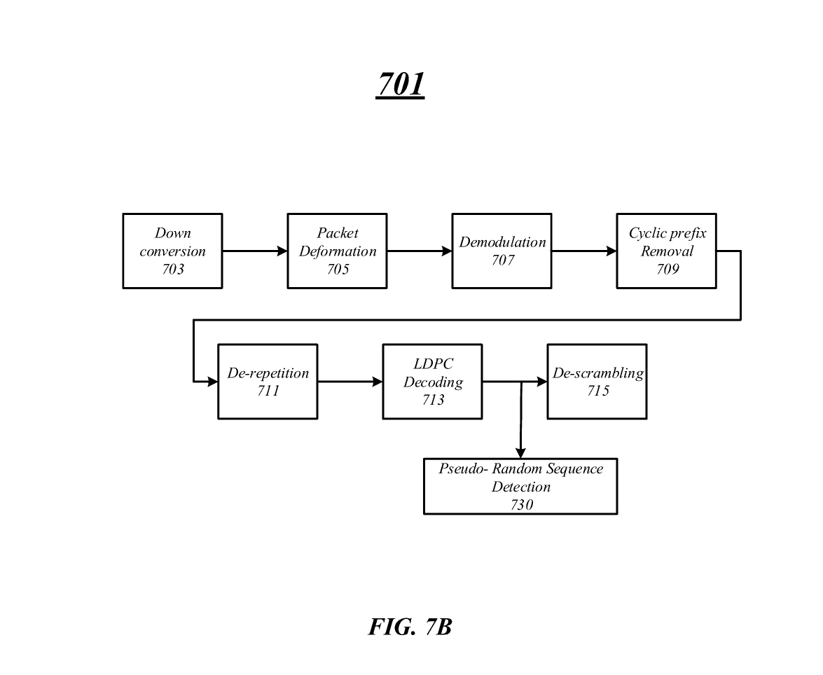

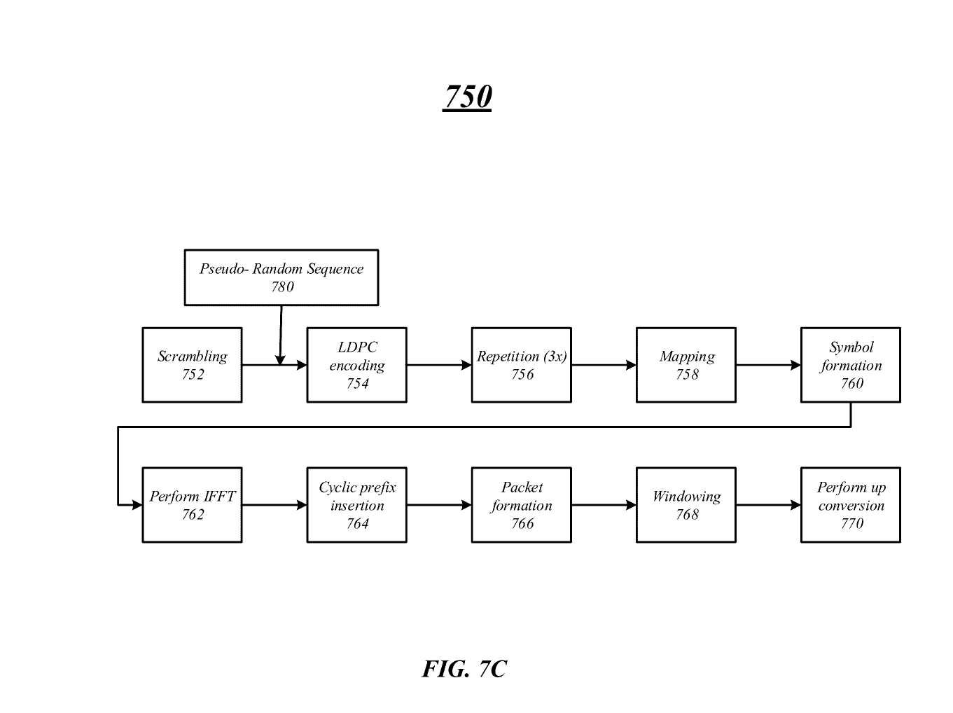

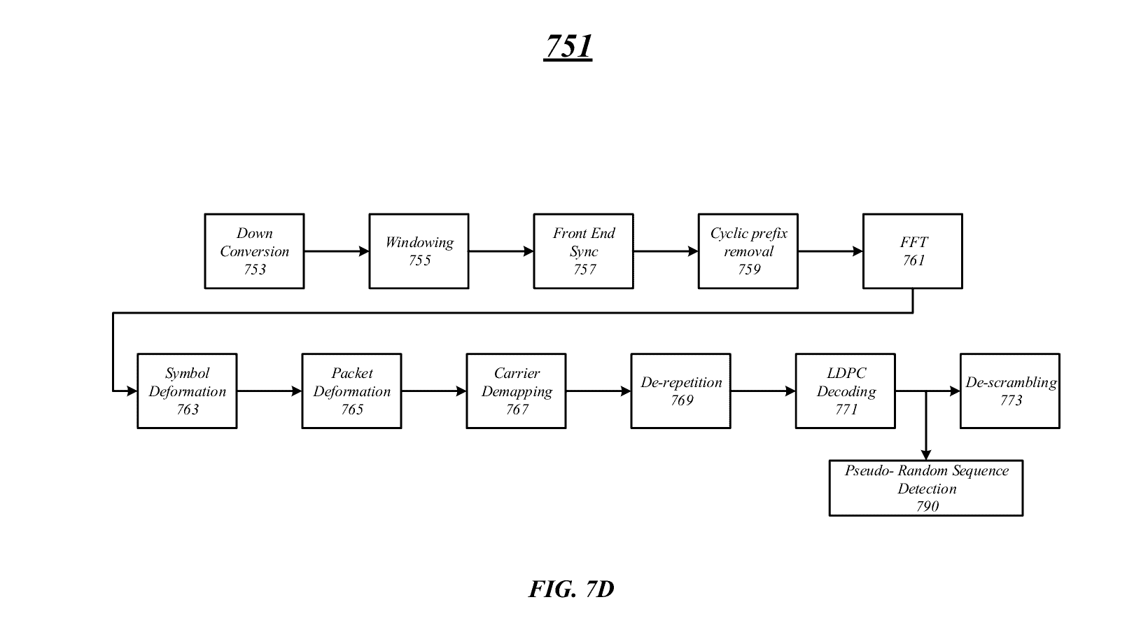

FIGS. 7A/7B illustrate example embodiments of processing flows 700 and 701 for processing a SC modulation packet including an end of packet indicator. Processing flow 700 illustrates an embodiment for sending an SC modulation packet and processing flow 701 illustrates an embodiment for receiving an SC modulation packet. Processing flow 700 may be the same processing flow 260 illustrated in FIG. 2D and processing flow 701 may be the same as processing flow 600 illustrated in FIG. 6, each with the addition of processing an end of packet indicator.

More specifically, processing flow 700 at block 720 may include adding a pseudo-random sequence to the packet after scrambling at block 702, but before LDPC encoding at block 704. The pseudo-random sequence may be used for end of packet detection and may be a known sequence combination of bits that is added after the last byte of data in the packet. In some embodiments, the pseudo-random sequence can be part of the padding for the LDPC full words or an additional symbol. The pseudo-random sequence may be limited to eight (8) bytes in length, however, various embodiments are not limited in this manner. As will be discussed in more detail below, the pseudo-random sequence may be used by the receiving PHY layer to detect the end of packet. Once the pseudo-random sequence is added, processing flow 700 may proceed as previously discussed above with respect to processing flow 260 discussed above.

At the receiving device, processing flow 701 may process the received packet as discussed above with respect to processing flow 600 in FIG. 6. However, after the LDPC decoding at block 713 the pseudo-random sequence may be detected at block 730. More specifically, the output of the LDPC decoding may be monitored if the sequence occurs in the data part or after the last data byte the packet will be terminated early and dropped. However, during the next retransmission of the packet a different seed value for the scrambler will be used and therefore the sequence will not appear in the data part of the packet. Thus, the receiving device will correctly receive the retransmission and detect the end of the packet indicator.

FIGS. 7C/7D illustrate example embodiments of processing flows 750 and 751 for processing an OFDM modulation packet including an end of packet indicator. Processing flow 750 illustrates an embodiment for sending an OFDM modulation packet and processing flow 751 illustrates an embodiment for receiving an OFDM modulation packet. Processing flow 750 may be the same processing flow 275 illustrated in FIG. 2D and processing flow 751 may be the same as processing flow 650 illustrated in FIG. 6, each with the addition of processing an end of packet indicator.

More specifically, processing flow 750 at block 780 may include adding a pseudo-random sequence to the packet after scrambling at block 752, but before LDPC encoding at block 754. The pseudo-random sequence may be used for end of packet detection and may be a known sequence combination of bits that is added after the last byte of data in the packet. In some embodiments, the pseudo-random sequence can be part of the padding for the LDPC full words or an additional symbol. The pseudo-random sequence may be limited eight (8) bytes in length, however, various embodiments are not limited in this manner. As will be discussed in more detail below, the pseudo-random sequence may be used by the receiving PHY layer to detect the end of packet. Once the pseudo-random sequence is added, processing flow 750 may proceed as previously discussed above with respect to processing flow 275 discussed above.

At the receiving device, processing flow 751 may process the received packet as discussed above with respect to processing flow 650 in FIG. 6. However, after the LDPC decoding at block 771 the pseudo-random sequence may be detected at block 790. More specifically, the output of the LDPC decoding may be monitored if the sequence occurs in the data part or after the last data byte the packet will be terminated early and dropped. However, during the next retransmission of the packet a different seed value for the scrambler will be used and therefore the sequence will not appear in the packet. Thus, the receiving device may correctly decode and detect the end of the packet indicator of the retransmission.

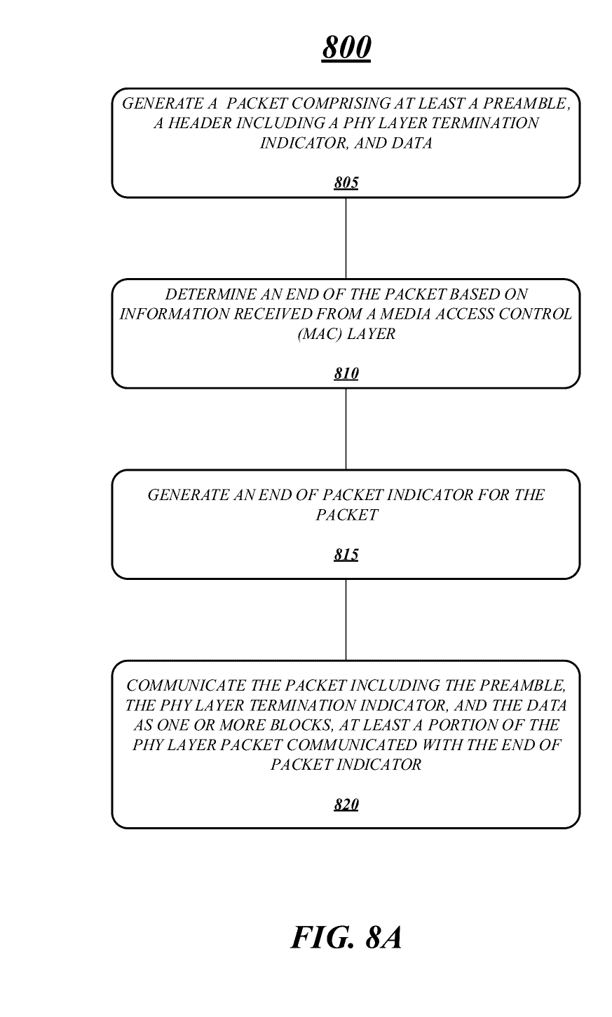

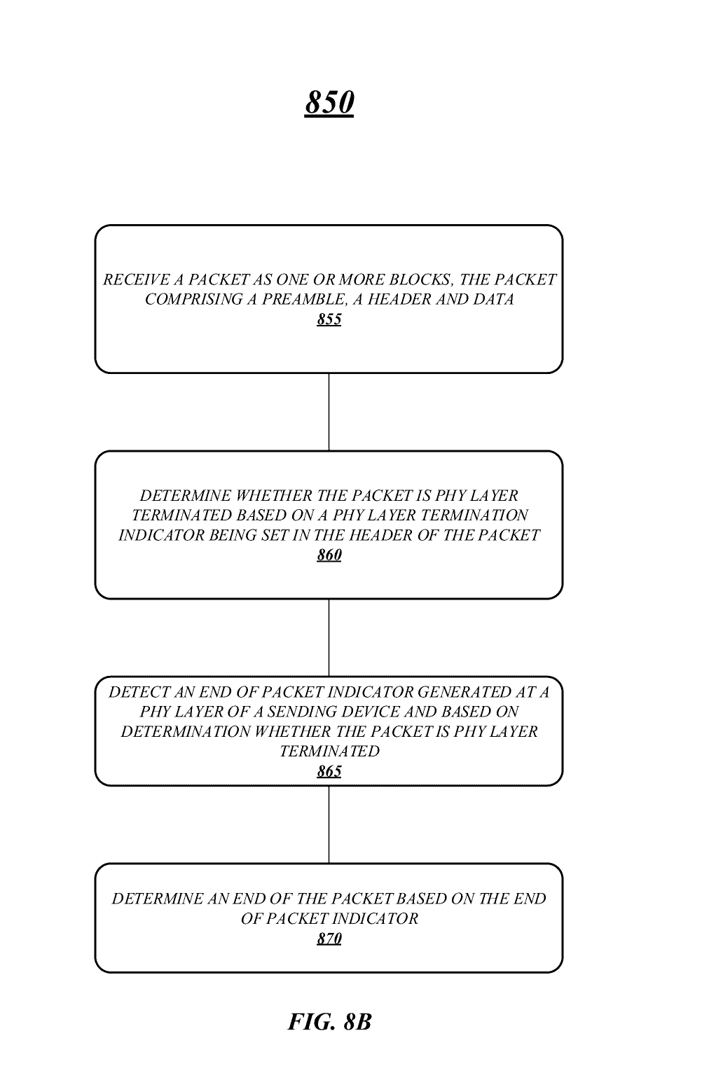

FIG. 8A illustrates an embodiment of a first logic flow diagram 800. The logic flow 800 may be representative of some or all of the operations executed by one or more embodiments described herein. For example, the logic flow 800 may illustrate operations performed by one or more systems or devices in FIGS. 1-7B. Various embodiments are not limited in this manner.

In various embodiments, logic flow 800 may include generating a packet comprising at least a preamble, a header including a PHY layer termination indicator, and data at block 805. For example, the packet may have a structure in accordance with the WiGig/802.11ad Standards and include a preamble having STF and CEF fields, a header, and data. However, in some embodiments, a reserve field of the packet may include a PHY layer termination indicator to indicate to a receiving device whether the packet is PHY layer terminated. In some embodiments, one or more bits may be set in a PHY layer termination indicator field if the packet is PHY layer terminated.

In some embodiments two or more bits may be used to indicate the PHY layer termination used to indicate the end of the packet. As previously discussed, at least four different methods may be used to indicate an end of packet, each may corresponding to a two bit sequence. For example, a first bit sequence (e.g. 00) in the PHY layer termination indicator field may indicate that an inverted polarity guard interval is used to indicate an end of packet. A second sequence (e.g. 01) may be used to indicate one or more Golay sequences sent in parallel with a last two blocks of the packet at a lower signal strength is used indicate an end of packet. A third sequence (e.g. 10) may be used to indicate one or more Golay sequences appended to a last guard interval of the packet is used to indicate an end of packet. A fourth sequence (e.g. 11) may be used to indicate a pseudo-random sequence is used to indicate an end of packet. Various embodiments are not limited to this example and any combination of bits may be used to indicate which end of packet indicator is used.

In some embodiments, the logic flow 800 at block 810 may include determining an end of the packet based on information from a MAC layer. For example, an empty MAC layer buffer may indicate the end of the packet. In another example, the MAC layer may communicate information to the PHY layer expressly indicating the end of packet. Various embodiments are not limited in this manner. The logic flow 800 may also include generating an end of packet indicator for the packet at block 815. As previously discussed at least one or four different methods may be used to indicate an end of the packet.

Further and in some embodiments, logic flow 800 includes communicating the packet including the preamble, the PHY layer termination indicator, and the data as one or more blocks, at least a portion of the PHY layer packet communicated with the end of packet indicator. As previously mentioned, the end of packet indicator may include one or more of an inverted polarity guard interval, one or more Golay sequences sent in parallel with a last two blocks of the packet at a lower signal strength, one or more Golay sequences appended to a last guard interval of the packet, or a pseudo-random sequence.

FIG. 8B illustrates an embodiment of a second logic flow diagram 850. The logic flow 850 may be representative of some or all of the operations executed by one or more embodiments described herein. For example, the logic flow 850 may illustrate operations performed by one or more systems or devices in FIGS. 1-7B. Various embodiments are not limited in this manner.

In various embodiments, logic flow 850 may include receiving a packet as one or more blocks, the packet comprising a preamble, a header and data at block 855. Further and at block 860, the logic flow 850 may include determining whether the packet is PHY layer terminated based on a PHY layer termination indicator being set in the header of the packet. As previously mentioned, one or more bits may be used to indicate whether a packet is PHY layer terminated and/or the type of end of packet indicator used to indicate the end of the packet.

In embodiments, logic flow 850 can include detecting an end of packet indicator generated at a PHY layer of a sending device based on the determination whether the packet is PHY layer terminated at block 865. More specifically, a PHY layer controller at a receiving device may be configured to detect a PHY layer terminated end of packet indicator if the packet is PHY layer terminated. Further and in embodiments where the type of end of packet indicator used is indicated in the header, the PHY layer controller uses this information to look for a specific end of packet indicator, such as one or more of the four methods previously discussed. Finally and a block 870, logic flow 850 may include determining an end of the packet based on the end of packet indicator.

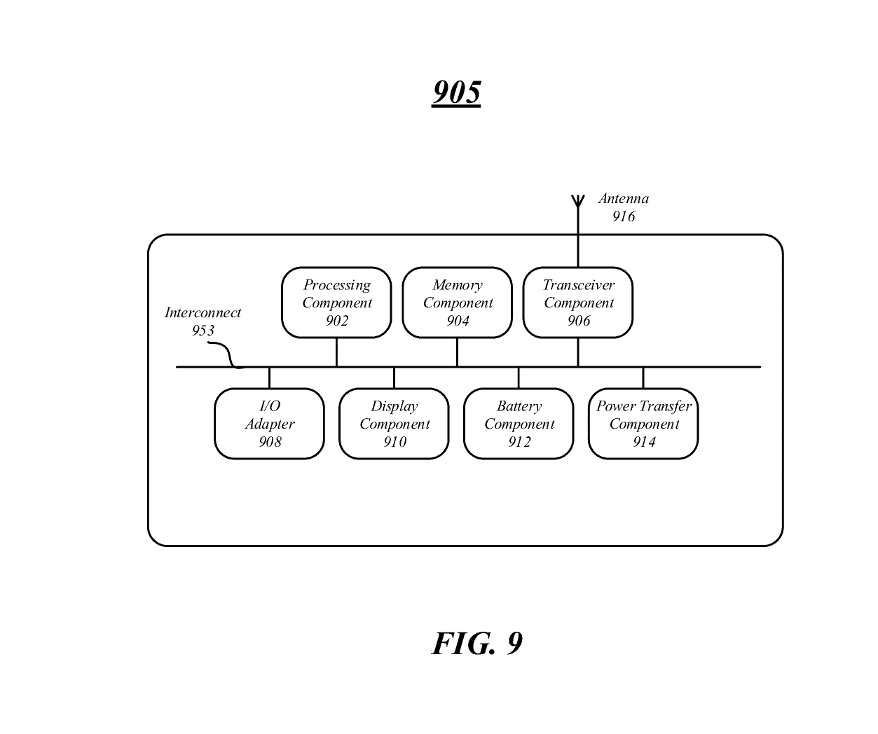

FIG. 9 illustrates an embodiment of a computing device 905. In various embodiments, computing device 905 may be representative of a computing device or system for use with one or more embodiments described herein, such as those discussed in FIGS. 1-8B.

In various embodiments, computing device 905 may be any type of computing device including a computing device including a personal computer (PC), laptop computer, ultra-laptop computer, netbook computer, ultrabook computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a computing device 905 also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a computing device 905 may be implemented as a smart phone capable of executing computer applications, as well as voice communications and/or data communications. Although some embodiments may be described with a computing device 905 implemented as a smart phone by way of example, it may be appreciated that other embodiments may be implemented using other wireless mobile computing devices as well. The embodiments are not limited in this context. In some embodiments, computing device 905 may also be a navigation system, infotainment system, embedded in home appliances, etc.

As shown in FIG. 9, computing device 905 may include multiple elements. One or more elements may be implemented using one or more circuits, components, registers, processors, software subroutine modules, or any combination thereof, as desired for a given set of design or performance constraints. Although FIG. 9 shows a limited number of elements in a certain topology by way of example, it can be appreciated that more or less elements in any suitable topology may be used in computing device 905 as desired for a given implementation. The embodiments are not limited in this context.

In various embodiments, computing device 905 may include one or more processing unit(s) 902. Processing unit(s) 902 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit or processing circuitry. The processing unit(s) 902 may be connected to and communicate with the other elements and components of the computing system via an interconnect 543, such as one or more buses, control lines, and data lines.

In one embodiment, computing device 905 may include memory 904 to couple to processing unit(s) 902. In various embodiments, the memory 904 may store data and information for use by the computing device 905.

Memory 904 may be coupled to processing unit(s) 902 via interconnect 853, or by a dedicated communications bus between processing unit(s) 902 and memory 904, as desired for a given implementation. Memory 904 may be implemented using any machine-readable or computer-readable media capable of storing data, including both volatile and non-volatile memory. In some embodiments, the machine-readable or computer-readable medium may include a non-transitory medium. The embodiments are not limited in this context.

The memory 904 can store instructions and data momentarily, temporarily, or permanently. The memory 904 may also store temporary variables or other intermediate information while the processing unit(s) 902 is executing instructions. The memory 904 is not limited to storing the above discussed data and may store any type of data.

The computing device 905 may include a transceiver 906 which includes one or more components and circuitry to transmit and receive information using radio-frequency signals. More specifically, the transceiver 906 may include circuitry to produce radio-frequency mobile radio signals which are to be sent and for processing radio-frequency mobile radio signals which have been received. To this end, the transceiver 906 may be coupled to one or more antenna 816. The transmitted or received mobile radio signals are in one or more particular frequency ranges, which are typically prescribed by the mobile radio standard(s) supported by the radio-frequency assemblies. For example, transceiver 906 may include circuitry to process information according to one or more IEEE standards, one or more peer-to-peer protocols, and so forth. Various embodiments are not limited in this manner and transceiver 906 may transmit or receive information via any standard in any frequency range with one more devices, as previously mentioned.

In various embodiments, the transceiver 906 may be used to communicate with one or more other devices or stations via one or more antennas 916. The transceiver 906 may send and receive information from the stations as one or more pockets, frames, and any other transmission structure in accordance with one or more protocols.

The computing device 905 may include input/output adapter 908. Examples of I/O adapter 908 may include Universal Serial Bus (USB) ports/adapters, IEEE 1394 Firewire ports/adapters, and so forth. The embodiments are not limited in this context.

For example, an I/O adapter 908 may also include an input device or sensor, such as one or more buttons, a keyboard, a keypad, a touchscreen display, a touch sensitive device, a microphone, a biometric finger printer reader, biometric eye scanner or any other device used for inputting information into computing device 905. Moreover, the I/O adapter 908 may be a sensor including any hardware or logic to detect one or more touches or inputs on or near a housing of the apparatus, a display of the apparatus including a touchscreen or touch sensitive display.

In various embodiments, the I/O adapter 908 may include one or more components to output information to a user. For example, the I/O adapter 908 may include a speaker to output an audible noise or a haptic feedback device to output a vibration. The I/O adapter 908 may be located any within or on computing device 905, or may be separate and connected to the computing device 905 via a wired or wireless connection.

The computing device 905 may also include a display 910. Display 910 may constitute any display device capable of displaying information received from processor units 902, such as liquid crystal display (LCD), cathode ray tube (CRT) display, a projector, and so forth. Various embodiments are not limited in this manner.

The computing device 905 may also include storage 912. Storage 912 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 912 may include technology to increase the storage performance enhanced protection for valuable digital media when multiple hard drives are included, for example. Further examples of storage 912 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In some embodiments, the computing device 905 may include a power transfer component 914, such an induction coil which may transfer electrical energy using electromagnetic induction. Various embodiments are not limited in this manner.

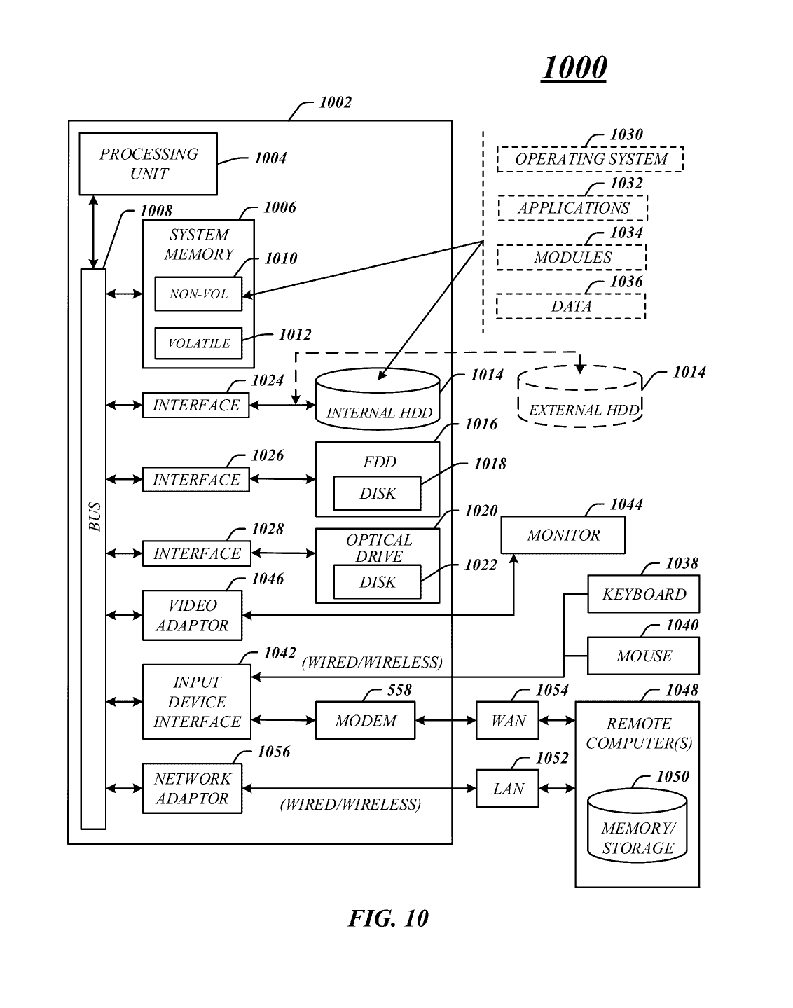

FIG. 10 illustrates an embodiment of an exemplary computing architecture 1000 suitable for implementing various embodiments as previously described. In one embodiment, the computing architecture 1000 may include or be implemented as part of system 105.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 includes a processing unit 1004, a system memory 1006 and a system bus 1008. The processing unit 1004 can be any of various commercially available processors.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the devices in FIGS. 1-9.

A user can enter commands and information into the computer 1002 through one or more wire/wireless input devices, for example, a keyboard 1038 and a pointing device, such as a mouse 1040. Other input devices may include microphones, infrared (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 558, or is connected to a communications server on the WAN 1054, or has other means for establishing communications over the WAN 1054, such as by way of the Internet. The modem 558, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 1002 family of standards, such as wireless devices operatively disposed in wireless communication (e.g., IEEE 1002.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 1002.11x (a, b, g, n, etc.) to provide secure, reliable, fast wireless connectivity. A Wi-Fi network can be used to connect computers to each other, to the Internet, and to wire networks (which use IEEE 1002.3-related media and functions).

The various elements of the system and devices as previously described with reference to FIGS. 1-10 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through twenty-five (1-25) provided below are intended to be exemplary and non-limiting.

In a first example, a system, device, controller, or an apparatus includes a transceiver to communicate one or more packets, and a physical (PHY) layer controller to generate a packet comprising at least a preamble, a header including a PHY layer termination indicator, and data, determine an end of the packet based on information received from a media access control (MAC) layer, generate an end of packet indicator for the packet, and communicate, via the transceiver, the packet including the preamble, the PHY layer termination indicator, and the data as one or more blocks, at least a portion of the packet communicated with the end of packet indicator.

In a second example and in furtherance of the first example, a system, device, controller, or an apparatus includes the PHY layer termination indicator comprising a bit in a reserve field of the header to indicate the packet is PHY layer terminated.

In a third example and in furtherance of any of the previous examples, a system, device, controller, or an apparatus includes the end of packet indicator comprising an inverted polarity guard interval sequence, and the PHY layer controller to append the inverted polarity guard interval sequence to a last data block of the one or more blocks to indicate the end of the packet.

In a fourth example and in furtherance of any of the previous examples, a system, device, controller, or an apparatus includes the end of packet indicator comprising one or more Golay sequences, and the PHY layer controller to communicate, via the transceiver, the one or more Golay sequences in parallel with a last two data blocks of the one or more blocks of the packet to indicate the end of the packet, the one or more Golay sequences communicated at a lower power than the PHY layer packet.

In a fifth example and in furtherance of any of the previous examples, a system, device, controller, or an apparatus includes the one or more Golay sequences comprising at least one Golay sequence used for one or more of a channel estimation and a short training field for the packet.

In a sixth example and in furtherance of any of the previous examples, a system, device, controller, or an apparatus includes the end of packet indicator comprising a pseudo-random sequence, and the PHY layer controller to append the pseudo-random sequence after a last byte of the data prior to low-density parity-check (LDPC) encoding.

In a seventh example and in furtherance of any of the previous examples, a system, device, controller, or an apparatus includes the end of packet indicator comprising one or more Golay sequences, and the PHY layer controller to append the one or more Golay sequences after a last guard interval value of the packet.

In an eighth example and in furtherance of any of the previous examples, a system, device, controller, or an apparatus includes the PHY layer controller to determine the end of the packet based on one or more of a MAC layer buffer being empty and/or an indication of the end of the packet received from the MAC layer.

In a ninth example and in furtherance of any of the previous examples, a method may include generating, by a physical (PHY) layer controller, a packet comprising at least a preamble, a header including a PHY layer termination indicator, and data, determining, by the PHY layer controller, an end of the packet based on information received from a media access control (MAC) layer, generating, by the PHY layer controller, an end of packet indicator for the packet, and communicating, by the PHY layer controller, the packet including the preamble, the PHY layer termination indicator, and the data as one or more blocks, at least a portion of the packet communicated with the end of packet indicator.

In a tenth example and in furtherance of any of the previous examples, a method may include appending, by the PHY layer controller, the end of packet indicator comprising an inverted polarity guard interval value to a last data block of the one or more blocks.

In an eleventh example and in furtherance of any of the previous examples, a method may include communicating, by the PHY layer controller, the end of packet indicator comprising one or more Golay sequences in parallel with a last two blocks of the one or more blocks and at a lower power than the packet.

In a twelfth example and in furtherance of any of the previous examples, a method may include using, by the PHY layer controller, at least one Golay sequence used for one or more of a channel estimation value and a short training field value as the one or more Golay sequences to indicate the end of the packet.

In a thirteenth example and in furtherance of any of the previous examples, a method may include appending, by the PHY layer controller, the end of packet indicator comprising a pseudo-random sequence after a last byte of the data, the appending to occur prior to performing low-density parity-check (LDPC) encoding.

In a fourteenth example and in furtherance of any of the previous examples, a method may include appending, by the PHY layer controller, the end of packet indicator comprising one or more Golay sequences after a last guard interval value of the packet.

In a fifteenth example and in furtherance of any of the previous examples, a system, device, controller, or an apparatus includes a transceiver to communicate one or more packets, and a physical (PHY) layer controller to receive a packet as one or more blocks, the packet comprising a preamble, a header and data, determine whether the packet is PHY layer terminated based on a PHY layer termination indicator set in the header of the packet, detect an end of packet indicator generated at a PHY layer of a sending device based on whether the packet is PHY layer terminated, and determine an end of the packet based on the end of packet indicator.

In a sixteenth example and in furtherance of any of the previous examples, a system, device, controller, or an apparatus includes the end of packet indicator comprising an inverted polarity guard interval value after a last data block of the one or more blocks to indicate the end of the packet.

In a seventeenth example and in furtherance of any of the previous examples, a system, device, controller, or an apparatus includes the end of packet indicator comprising one or more Golay sequences received in parallel with a last two blocks of the one or more blocks of the packet to indicate the end of the packet, the one or more Golay sequences communicated at a lower power than the packet.

In an eighteenth example and in furtherance of any of the previous examples, a system, device, controller, or an apparatus includes the one or more Golay sequences comprising at least one Golay sequence used for one or more of a channel estimation value and a short training field value in the preamble of the packet.

In a nineteenth example and in furtherance of any of the previous examples, a system, device, controller, or an apparatus includes the end of packet indicator comprising a pseudo-random sequence appended after a last byte of data, and the PHY layer controller to detect the pseudo-random sequence after performing low-density parity-check (LDPC) decoding.

In a twentieth example and in furtherance of any of the previous examples, a system, device, controller, or an apparatus includes the end of packet indicator comprising one or more Golay sequences appended after a last guard interval value in a last block of the one or more blocks for the packet.

In a twenty-first example and in furtherance of any of the previous examples, a method may include receiving, by a physical (PHY) layer controller, a packet as one or more blocks, the packet comprising a preamble, a header and data, determining, by the PHY layer controller, whether the packet is PHY layer terminated based on a PHY layer termination indicator set in the header of the packet, detecting, by the PHY layer controller, an end of packet indicator generated at a PHY layer of a sending device based on the determination whether the packet is PHY layer terminated or not, and determining, by the PHY layer controller, an end of the packet based on the end of packet indicator.

In a twenty-second example and in furtherance of any of the previous examples, a method may include detecting the end of packet indicator comprising an inverted polarity guard interval value after a last data block of the one or more blocks.

In a twenty-third example and in furtherance of any of the previous examples, a method may include detecting the end of packet indicator comprising one or more Golay sequences received in parallel with a last two blocks of the one or more blocks, the one or more Golay sequences communicated at a lower power than the packet.

In a twenty-fourth example and in furtherance of any of the previous examples, a method may include detecting the end of packet indicator comprising a pseudo-random sequence appended after a last byte of data, the detecting the pseudo-random sequence to occur after performing low-density parity-check (LDPC) decoding.

In a twenty-fifth example and in furtherance of any of the previous examples, a method may include detecting the end of packet indicator comprising one or more Golay sequences appended after a last guard interval value for the packet.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “including” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a transceiver to communicate one or more packets; and
a physical (PHY) layer controller to:
generate a packet comprising at least a preamble, a header including a PHY layer termination indicator, and data;
determine an end of the packet based on information received from a media access control (MAC) layer;
generate an end of packet indicator for the packet; and
communicate, via the transceiver, the packet including the preamble, the PHY layer termination indicator, and the data as one or more blocks, at least a portion of the packet communicated with the end of packet indicator.

2. The apparatus of claim 1, the PHY layer termination indicator comprising a bit in a reserve field of the header to indicate the packet is PHY layer terminated.

3. The apparatus of claim 2, the end of packet indicator comprising an inverted polarity guard interval sequence, and the PHY layer controller to append the inverted polarity guard interval sequence to a last data block of the one or more blocks to indicate the end of the packet.

4. The apparatus of claim 2, the end of packet indicator comprising one or more Golay sequences, and the PHY layer controller to communicate, via the transceiver, the one or more Golay sequences in parallel with a last two data blocks of the one or more blocks of the packet to indicate the end of the packet, the one or more Golay sequences communicated at a lower power than the PHY layer packet.

5. The apparatus of claim 4, the one or more Golay sequences comprising at least one Golay sequence used for one or more of a channel estimation and a short training field for the packet.

6. The apparatus of claim 2, the end of packet indicator comprising a pseudo-random sequence, and the PHY layer controller to append the pseudo-random sequence after a last byte of the data prior to low-density parity-check (LDPC) encoding.

7. The apparatus of claim 2, the end of packet indicator comprising one or more Golay sequences, and the PHY layer controller to append the one or more Golay sequences after a last guard interval value of the packet.

8. The apparatus of claim 2, the PHY layer controller to determine the end of the packet based on one or more of a MAC layer buffer being empty and/or an indication of the end of the packet received from the MAC layer.

9. A computer-implemented method comprising:
generating, by a physical (PHY) layer controller, a packet comprising at least a preamble, a header including a PHY layer termination indicator, and data;
determining, by the PHY layer controller, an end of the packet based on information received from a media access control (MAC) layer;
generating, by the PHY layer controller, an end of packet indicator for the packet; and
communicating, by the PHY layer controller, the packet including the preamble, the PHY layer termination indicator, and the data as one or more blocks, at least a portion of the packet communicated with the end of packet indicator.

10. The computer-implemented method of claim 9, comprising appending, by the PHY layer controller, the end of packet indicator comprising an inverted polarity guard interval value to a last data block of the one or more blocks.

11. The computer-implemented method of claim 9, comprising communicating, by the PHY layer controller, the end of packet indicator comprising one or more Golay sequences in parallel with a last two blocks of the one or more blocks and at a lower power than the packet.

12. The computer-implemented method of claim 11, comprising using, by the PHY layer controller, at least one Golay sequence used for one or more of a channel estimation value and a short training field value as the one or more Golay sequences to indicate the end of the packet.

13. The computer-implemented method of claim 9, comprising appending, by the PHY layer controller, the end of packet indicator comprising a pseudo-random sequence after a last byte of the data, the appending to occur prior to performing low-density parity-check (LDPC) encoding.

14. The computer-implemented method of claim 9, comprising appending, by the PHY layer controller, the end of packet indicator comprising one or more Golay sequences after a last guard interval value of the packet.

15. An apparatus, comprising:
a transceiver to communicate one or more packets; and
a physical (PHY) layer controller to:
receive a packet as one or more blocks, the packet comprising a preamble, a header and data;
determine whether the packet is PHY layer terminated based on a PHY layer termination indicator set in the header of the packet;
detect an end of packet indicator generated at a PHY layer of a sending device based on whether the packet is PHY layer terminated; and
determine an end of the packet based on the end of packet indicator.

16. The apparatus of claim 15, the end of packet indicator comprising an inverted polarity guard interval value after a last data block of the one or more blocks to indicate the end of the packet.

17. The apparatus of claim 15, the end of packet indicator comprising one or more Golay sequences received in parallel with a last two blocks of the one or more blocks of the packet to indicate the end of the packet, the one or more Golay sequences communicated at a lower power than the packet.

18. The apparatus of claim 17, the one or more Golay sequences comprising at least one Golay sequence used for one or more of a channel estimation value and a short training field value in the preamble of the packet.

19. The apparatus of claim 17, the end of packet indicator comprising a pseudo-random sequence appended after a last byte of data, and the PHY layer controller to detect the pseudo-random sequence after performing low-density parity-check (LDPC) decoding.

20. The apparatus of claim 17, the end of packet indicator comprising one or more Golay sequences appended after a last guard interval value in a last block of the one or more blocks for the packet.

21. A computer-implemented method, comprising:
receiving, by a physical (PHY) layer controller, a packet as one or more blocks, the packet comprising a preamble, a header and data;
determining, by the PHY layer controller, whether the packet is PHY layer terminated based on a PHY layer termination indicator set in the header of the packet;
detecting, by the PHY layer controller, an end of packet indicator generated at a PHY layer of a sending device based on the determination whether the packet is PHY layer terminated or not; and
determining, by the PHY layer controller, an end of the packet based on the end of packet indicator.

22. The computer-implemented method of claim 21, comprising detecting the end of packet indicator comprising an inverted polarity guard interval value after a last data block of the one or more blocks.

23. The computer-implemented method of claim 21, comprising detecting the end of packet indicator comprising one or more Golay sequences received in parallel with a last two blocks of the one or more blocks, the one or more Golay sequences communicated at a lower power than the packet.

24. The computer-implemented method of claim 21, comprising detecting the end of packet indicator comprising a pseudo-random sequence appended after a last byte of data, the detecting the pseudo-random sequence to occur after performing low-density parity-check (LDPC) decoding.

25. The computer-implemented method of claim 21, comprising detecting the end of packet indicator comprising one or more Golay sequences appended after a last guard interval value for the packet.
